(19) United States
(12) Patent Application Publication
(10) Pub. No.: US 2005/0269730 A1
(43) Pub. Date: Dec. 8, 2005

(54) Method for manufacturing a wood cement board

(75) Inventor: Fumihiro Asakura, Nagoya-shi (JP)

Correspondence Address: Donald S. Dowden;Cooper & Dunham LLP, 1185 Avenue of the Americas, New York, NY, 10036, US

(73) Assignee: Nichiha Corporation, Nagoya-shi (JP)

(21) Appl. No.: 11/098,936

(22) Filed: Apr. 4, 2005

(30) Foreign Application Priority Data
Jun. 3, 2004 (JP) JP2004-165179

(51) Int. Cl. B27N 3/02

(52) U.S. Cl. 264/122

(57) ABSTRACT

The object of the present invention is to provide a method for the manufacturing of a wood cement board in which the curing of the cement can be smoothly carried out even if the wood reinforcement used originates from a sort of wood containing a large amount of cement curing inhibitor. To attain said object, the present invention provides a method for the manufacturing of a wood cement board including; scattering an ingredient wherein a sodium alum produced from aluminum sulfate and sodium sulfate, and sodium silicate are added to a mixture containing a cementitious inorganic powder and a wood reinforcement on a base panel to form a mat, then primarily curing the said mat by pressing and heating it under its moist points and, then curing the primarily cured mat at room temperature or in an autoclave. In the method, the aluminum sulfate and sodium silicate in the sodium alum improve the primary curing strength of the mat, with sodium sulfate improving the final curing strength of the mat.

### FIELD OF THE INVENTION

The present invention relates to a method for manufacturing a wood cement board to be used mainly as a building material.

### BACKGROUND OF ART

1. Background of the Invention

Hitherto a wood cement board, wherein wood reinforcement(s) such as wood flake, wood wool, wood pulp or the like is (are) mixed into a cement-like material, has been provided as a building board material for such as exterior wall board, interior wall board or the like.

As for the method of manufacturing said wood cement board, a dry method has been provided, said dry method comprising the preparation of a mixture of a cementitious inorganic powder, and a wood reinforcement, and then scattering said mixture onto a base panel such as a mold panel, transporting panel, flat panel or the like, to form a mat, then primarily curing said mat by pressing and heating under its moist points, removing a resulting primarily cured mat, and then curing said primarily cured mat in an autoclave.

Nevertheless, in said traditional dry method, when a wood reinforcement originating from a type of wood, containing a large amount of cement curing inhibitor, saccharides or the like; for woods such as of larch wood, yellow lauan wood, or the like, a long time may be necessary to cure primarily cementitious inorganic powder, and if said mat is removed from said base board in a short time, the curing of said cementitious inorganic powders will be incomplete, resulting in said mat's spring back and producing a mat being primarily cured, but misshapen.

It is desirable to use wood-scrap as wood reinforcement from the perspective that the utilization thereof makes effective use of the wood as a resource, but said wood-scrap commonly includes types of wood containing a large amount of saccharides, which is very troublesome to sort through and remove.

Further, even concerning the same sort of wood, the specific saccharides content of the core, and that of the outside-part may be different, resulting in a problem in that the time required for the removal of said primarily cured mat from said base panel may vary.

Accordingly, without regard to the sort of wood being used as said wood reinforcement, or comprising core or outside part thereof, the practical use of a method for manufacturing a wood cement board in which the time from the primary curing of said mat to the removal of said mat from said base panel is shorter and substantially constant has been long needed

Further, inorganic aggregates such as fly ash are inexpensive and advantageous from the standpoint of resource, but said inorganic aggregate is problematic in that it is apt to inhibit the cement from curing.

2. Prior Art

Hitherto, alkaline earth metal chlorides such as magnesium chloride, calcium chloride, or the like, as well as water glass, formic acid, or the like have been used to promote the curing of cement. Nevertheless, said alkaline earth metal chlorides pollute the environment, since said alkaline earth metal chlorides contain chlorine, and water glass and formic acid solely have insufficient cement curing effect. Further, the use of alum such as potassium alum, sodium alum, aluminium alum, or the like has been proposed as a promoter of cement curing (see Patent Literatures 1 to 5).

Said alum has been used alone, or in combination with a few other kinds of alums, or together with fluoride, calcium aluminate, gypsum, active silica, alkaline metal salt of carbonic acid, formic acid; or the like.
Patent Reference 1: TOKKAI JP2000-16848 Claims
Patent Reference 2: TOKKAI JP2001-261393 Claim 1
Patent Reference 3: TOKKAISHO JP56-155050 Claims
Patent Reference 4: TOKKAIHEI JP09-309754 Claims
Patent Reference 5: TOKKAISHO JP55-113513 Claims

### DISCLOSURE OF THE INVENTION

The Problems to be Solved in the Invention

It has been unexpectable that said traditional cement curing promoters have the same effect on many kinds of cement curing inhibitors, and further there is no guarantee of both sufficiently high primary curing strength, and final curing strength, of the mat.

To exercise advantageously the effects of said traditional cement curing promoters, a special kind of cement, largely containing C3A component, or gypsum component, may be used instead of common portland cement, however, said special cement is expensive.

Means to Solve Said Problems

As a means to solve said traditional problems, the present invention provides a method for manufacturing a wood cement board comprising; the scattering of an ingredient, wherein a sodium alum, produced from aluminum sulfate and sodium sulfate, and sodium silicate are added to a mixture containing a cementitious inorganic powder and wood reinforcement on a base panel to form a mat, then primarily curing said mat by pressing and heating under its moist points, and curing said primarily cured mat at room temperature, or in an autoclave.

It is preferable that the weight ratio of aluminum sulfate and sodium sulfate in said sodium alum is set to be in the range of between 80:20 to 50:50, and the weight ratio of said sodium alum and sodium silicate is set to be in the range of between 25:75 to 75:25, with 2.0 to 5.0 parts by weight of a curing accelerator mixture of said sodium alum and sodium silicate being added to 100 parts by weight of a mixture of said cementitious inorganic powder and said wood reinforcement.

For the present invention said wood reinforcement may contain a wood material originating from a sort of wood containing a large amount of cement curing inhibitor. Further, commonly said primary curing of said mat is carried out on said base panel, while said curing at room temperature or in said autoclave is carried out without said base panel.

Effect of the Invention

[Operation]

Aluminum sulfate is resistant mainly to wood cement cure inhibitor, so that even if a sort of wood, containing a large amount of cement curing inhibitors is used as the material for said wood reinforcement, a high primary curing strength is quickly realized, and sodium silicate is resistant mainly to inorganic cement curing inhibitors, so that even if an inorganic aggregate such as fly ash, which is inexpensive and plentiful is used, a high primary curing strength is quickly realized, with sodium sulfate improving the final curing strength of the cement, resulting in a high strength product being provided.

[Effects]

Accordingly, many sorts of wood can be selected as sources of wood reinforcement, so that even wood-scrap produced by the demolition of buildings or the like can be provided as a source of wood reinforcement without selection.

Further, in the present invention, an inorganic aggregate such as fly ash which is inexpensive and advantageous from the standpoint of resource can be used, so that even if said wood reinforcement and said inorganic aggregate are used, and further, if an inexpensive common portland cement is used as a cemetitious inorganic powder, the hardness of the primarily cured mat is quickly realized, so that the time until the removal of said mat from said base panel can largely be shortened, and a final product having high strength can be provided.

### PREFERED EMBODIMENT OF THE INVENTION

The present invention is illustrated precisely below.

[Cementitious Inorganic Powder]

The cementitious inorganic powder used in the present invention is a water curable inorganic powder containing calcium silicate as its main component; said inorganic powder may be such as common portland cement, a high-early-strength cement, a blast furnace cement in which blast furnace slag is mixed in with portland cement, a fly ash cement in which fly ash is mixed in with portland cement, silica cement in which silica material such as volcanic ash, white earth, or the like is mixed in with portland cement, an alumina cement, blast furnace slag, or the like.

Since common portland cement is available in the present invention, the manufacturing process can be simplified, and an inexpensive product can be provided.

[Wood Reinforcement]

The wood reinforcement used in the present invention may be such as wood flour, wood wool, wood flake, wood fiber, wood pulp, bundled wood fiber, or the like, and a material containing lignocellulose as its main component, such as bamboo fiber, hemp fiber, bagasse, chaff, rice straw, or the like, may be mixed in with said wood reinforcement. A preferable wood reinforcement may be such as a wood flake having a width in the range of between 0.5 and 2.0 mm, and a length in the range of between 1 and 20 mm, with an aspect ratio (length/thickness) in the range of between 20 and 30, said bundled wood fiber branched and/or bent and/or folded, said bundled wood fiber having a diameter in the range of between 0.1 and 2.0 mm, and a length in the range of between 2 and 35 mm, or the like.

Said wood reinforcement may be added to said cementitious inorganic powder in an amount in the range of between 5 and 50% by weight in absolute dry condition.

[Aggregates]

Besides said cementitious inorganic powder and said wood reinforcement, aggregates, especially light weight aggregates may be added. Said aggregates may be such as silica sand, silica powder, diatomaceous earth, silas, mica, silica fume, fly ash, slag, or the like, and said light weight aggregates may be such as pearlite, silas balloon, expanded shale, expanded clay, burned diatomaceous earth, coal cinders, or the like. Said aggregates may be added to the total solid mixture commonly in an amount of between 5 and 30% by weight.

[Curing Promoters]

In the present invention, sodium alum produced from aluminum sulfate and sodium sulfate, and sodium silicate are used as curing promoters for said cementitious inorganic powder. In said curing promoters, the weight ratio of aluminum sulfate and sodium sulfate in said sodium alum may be set to be in the range of between 80:20 and 50:20, but desirably between 80:20 and 70:30, and the weight ratio of said sodium alum and sodium silicate may be set to be 25:75 and 75:25, but desirably between 30:70 and 70:30, but more desirably between 40:60 and 60:40.

The sodium sulfate in said sodium alum may improve the final curing strength of said cement, and aluminum sulfate is resistant mainly to wood cement curing inhibitor, and further the sodium silicate added to said sodium alum is resistant mainly to inorganic cement curing inhibitor, and, together they may improve the primary curing strength.

Commonly, said mixture of curing promoters is prepared by mixing a water solution of sodium sulfate and a water solution of aluminum sulfate to first prepare a water solution of sodium alum of about 15% by weight, and then to add about 20% of a water solution of sodium silicate to said sodium alum water solution while agitating. Commonly 2.0 to 5.0 parts by weight, desirably 2.5 to 4.5, parts by weight, and more desirably 3.0 to 4.0 parts by weight of said mixtures of curing promoters of aluminum sulfate, sodium sulfate, and sodium silicate may be added to 100 weight parts of the mixture containing said cementitious inorganic powder and said wood reinforcement.

[Third Components]

If desired, curing promoters such as slaked lime, quicklime, gypsum, magnesium sulfate, aluminate, water glass, or the like as well as aluminum sulfate, sodium sulfate and sodium silicate; water proofing agents or water repellent agents such as wax, paraffin, surface active agents, silicone, or the like may be added to the composition of said mixture.

Further, crushed plastics such as polyethylene, polypropylene, polystyrene, polyester, polyamide, or the like, crushed textile, crushed foamed plastics, foamed plastic beads such as foamed polystyrene beads, foamed polyethylene beads, foamed polypropylene beads, or the like, crushed scrap building board such as ceramic siding, wood flake-cement board, pulp cement board or the like may be added thereto.

[Manufacture of Wood Cement Board]

To manufacture said wood cement board, the semidry method is applicable. In said semidry method, the water content of an ingredient, which is a mixture of said components, is adjusted to be commonly 30 to 50% by weight, by adding water to said ingredient, and said ingredient being scattered on a base panel such as a mold panel, transportation panel, flat panel or the like to form a mat, after which said mat is pressed and heated together with said base panel, to be primarily cured.

Commonly in said pressing and heating process, said mat is heated at a temperature of 60 to 100° C., and pressed at 2 to 5 MPa.

After said primary curing, said primarily cured mat is removed from said base panel, and cured at room temperature, or in an autoclave. In the present invention, since the strength of said primarily cured mat is quickly realized, the time required before the removal of said mat from said base panel can be greatly reduced. The conditions autoclave curing may commonly require humidity higher than 85% RH, and a temperature of 150˜180° C. for 5 to 12 hours. After curing at room temperature, or in an autoclave, the resulting cured mat is dried and surface-treated before becoming a finished product. In a case where said secondary curing is carried out in an autoclave, the original effects of aluminum sulfate, sodium sulfate and sodium silicate on the resulting wood cement board (said effect may be a large dimension variation by the water absorption of said curing promoter mixture) can be suppressed.

Said wood cement board of the present invention may be a board having two or three layer structure. In the case of a two layer structure, firstly an ingredient, containing fine wood reinforcement is scattered on said base board to form a mat, after which an ingredient containing a coarse wood reinforcement is scattered on said mat, forming a mat having a two layer structure, after which said mat having a two layer structure is pressed and heated, said mat of the ingredient containing the fine wood reinforcement forming a surface layer having a thick structure, and said mat of the ingredient containing the coarse wood reinforcement forming a back layer having a coarse structure.

Further, in a case where the board has a three layer structure, a further third ingredient containing fine wood reinforcement is scattered on said mat of the ingredient containing coarse wood reinforcement, to form a mat having a three layer structure, after which said mat is pressed and heated, said mat of the ingredient containing coarse wood reinforcement forming a core layer having a coarse structure, said third mat of the ingredient containing fine wood reinforcement forming a back layer having a thick structure.

Further, to manufacture a board having a three layer structure, a pair of mats, each having two layer structure may be lapped together, and then said lapped mat is pressed and heated. In the case where a pair of mats are lapped together, their coarse structured back layers join each other.

### EXAMPLES 1 to 7, COMPARISONS 1 to 5

Ingredient A for the surface and back layers, said Ingredient A being a mixture having a composition as shown in Table 1, was scattered on a base panel to form a surface layer mat, after which Ingredient B for the core layer, said Ingredient B being a mixture having a composition shown in Table 1 was scattered on said surface layer mat to form a core layer mat, with said Ingredient A being further scattered on said core layer mat to form a back layer mat. The resulting mat having three layer structure was then pressed at 3 MPa and heated at 70° C. for 6 hours with said base panel for the primary curing.

After said primary curing, the resulting primarily cured mat was removed from said base panel, and cured in an autoclave at 160 to 170° C. for 7 hours, finally producing a wood cement board sample having three layer structure. Mechanical properties of each sample are shown in Table 1.

Insert Table 1

The weight ratio of aluminum sulfate and sodium sulfate, and weight ratio of sodium alum and sodium silicate, and the amount of said mixture of curing promoters to be added (parts by weight) in each sample are as follows:
EXAMPLE 1
   aluminum sulfate:sodium sulfate=80:20
   sodium alum:sodium silicate=50:50
   Amount of curing promoter to be added 3.5 parts by weight
EXAMPLE 2
   aluminum sulfate:sodium sulfate=75:25
   sodium alum:sodium silicate=50:50
   Amount of curing promoter to be added 3.5 parts by weight
EXAMPLE 3
   aluminum sulfate:sodium sulfate=50:50
   sodium alum:sodium silicate=50:50
   Amount of curing promoter to be added 3.5 parts by weight
EXAMPLE 4
   aluminum sulfate:sodium sulfate=75:25
   sodium alum:sodium silicate=65:35
   Amount of curing promoter to be added 3.5 parts by weight
EXAMPLE 5
   aluminum sulfate:sodium sulfate=75:25
   sodium alum:sodium silicate=35:65
   Amount of curing promoter to be added 3.5 parts by weight
EXAMPLE 6
   aluminum sulfate:sodium sulfate=75:25
   sodium alum:sodium silicate=50:50
   Amount of curing promoter to be added 2.0 parts by weight
EXAMPLE 7
   aluminum sulfate:sodium sulfate=75:25
   sodium alum:sodium silicate=50:50
   Amount of curing promoter to be added 5.0 parts by weight
COMPARISON 1
   aluminum sulfate:sodium sulfate=90:10
   sodium alum:sodium silicate=50:50
   Amount of curing promoter to be added 3.5 parts by weight
COMPARISON 2
   aluminum sulfate:sodium sulfate=75:25
   sodium alum:sodium silicate=10:90
   Amount of curing promoter to be added 3.5 parts by weight
COMPARISON 3
   aluminum sulfate:sodium sulfate=75:25
   sodium alum:sodium silicate=90:10
   Amount of curing promoter to be added 3.5 parts by weight
COMPARISON 4
   aluminum sulfate:sodium sulfate=75:25
   sodium alum:sodium silicate=50:50
   Amount of curing promoter to be added 1.0 part by weight
COMPARISON 5
   Calcium chloride 2.0 parts by weight

The samples in EXAMPLE 1 to 7 relate to the present invention, and each sample has substantially the same bending strength after primary curing (primary curing strength) and substantially the same bending strength after secondary curing (final curing strength) as the traditional sample from COMPARISON 5 in which 2.0 parts by weight of calcium chloride was added instead of said mixtures of curing promoters and further, each sample has a small thickness swelling ratio (spring back).

On the other hand, the sample from COMPARISON 1 in which the weight ratio of aluminum sulfate in said sodium alum is higher than 80 (90), has a less final curing strength and slightly greater spring back than the samples from each EXAMPLE. Further, the sample from COMPARISON 2 in which the weight ratio of sodium alum is less than 25 (10) has less primary curing, less final curing strength and greater spring back than the samples from each EXAMPLE, furthermore, the sample from COMPARISON 3 in which the weight ratio of sodium silicate is less than 25 (10), has fairly less final curing strength and greater spring back than the samples from each EXAMPLE, and the sample from COMPARISON 4 in which the amount of said mixture of curing promoters to be added is less than 2.0 parts by weight (1.0 part by weight) has less primary curing, less final curing strength and greater spring back, even though said mixture of curing promoters has a composition in the range of the present invention.

### EXAMPLES 8 to 11, COMPARISON 6 to 9

A mat was formed by scattering a mixture having a composition as shown in Table 2, and said mat was pressed at 3 MPa and heated at 70° C. for 6 hours with the base panel for the primary curing, and the resulting primarily cured mat was removed from said base panel, and then cured at the room temperature for 4 days for final curing to prepare said wood cement board samples.

The mechanical properties of each sample are shown in Table 2.

Insert Table 2

The weight ratio of aluminum sulfate and sodium sulfate, and weight ratio of sodium alum and sodium silicate, and the amount of said mixture of curing promoters to be added (parts by weight) in each sample are as follows:
EXAMPLE 8
   aluminum sulfate:sodium sulfate=80:20
   sodium alum:sodium silicate=50:50
   Amount of curing promoter to be added 3.5 parts by weight
EXAMPLE 9
   aluminum sulfate:sodium sulfate=50:50
   sodium alum:sodium silicate=50:50
   Amount of curing promoter to be added 3.5 parts by weight
EXAMPLE 10
   aluminum sulfate:sodium sulfate=75:25
   sodium alum:sodium silicate=50:50
   Amount of curing promoter to be added 2.0 parts by weight
EXAMPLE 11
   aluminum sulfate:sodium sulfate=75:25
   sodium alum:sodium silicate=50:50
   Amount of curing promoter to be added 5.0 parts by weight
COMPARISON 6
   aluminum sulfate:sodium sulfate=90:10
   sodium alum:sodium silicate=50:50
   Amount of curing promoter to be added 3.5 parts by weight
COMPARISON 7
   aluminum sulfate:sodium sulfate=75:25
   sodium alum:sodium silicate=10:90
   Amount of curing promoter to be added 3.5 parts by weight
COMPARISON 8
   aluminum sulfate:sodium sulfate=75:25
   sodium alum:sodium silicate=50:50
   Amount of curing promoter to be added 1.0 part by weight
COMPARISON 9
   Calcium chloride 2.0 part by weight

Each sample from EXAMPLES 8 to 11 relating to the present invention has substantially the same primary and final curing strength as does the traditional sample from COMARISON 9, which uses calcium chloride, and has little spring back.

On the other hand, the sample from COMPARISON 6 in which weight ratio of sodium sulfate in said sodium alum is less than 20 (10) has less final curing strength, and sample from COMPARISON 7 in which weight ratio of sodium alum is less than 25 (10) has less final curing strength and greater spring back. Further, the sample from COMPARISON 8, in which the amount of said mixture of curing promoters of the present invention added is less than 2.0 parts by weight (1.0 part by weight), has less final curing strength and greater spring back.

### EXAMPLES 12 to 15, COMPARISON 10 to 11

Using Ingredient A for the surface and back layers which is a mixture having a composition shown in Table 3 and Ingredient B for the core layer which is a mixture having a composition also shown in Table 3, wood cement board samples having three layer structure were manufactured by the same method as in EXAMPLES 1 to 7.

The mechanical properties of each sample are shown in Table 3.

Insert Table 3

The weight ratio of aluminum sulfate and sodium sulfate, and the amount of said mixture of curing promoters to be added (parts by weight) in each sample are as follows.
EXAMPLE 12
   aluminum sulfate:sodium sulfate=75:25
   sodium alum:sodium silicate=50:50
   Amount of curing promoter to be added 3.5 parts by weight
EXAMPLE 13
   aluminum sulfate:sodium sulfate=75:25
   sodium alum:sodium silicate=37.5:62.5
   Amount of curing promoter to be added 3.5 parts by weight
EXAMPLE 14
   aluminum sulfate:sodium sulfate=75:25
   sodium alum:sodium silicate=25:75
   Amount of curing promoter to be added 3.5 parts by weight
EXAMPLE 15
   aluminum sulfate:sodium sulfate=75:25
   sodium alum:sodium silicate=75:25
   Amount of curing promoter to be added 3.5 parts by weight
COMPARISON 10
   aluminum sulfate:sodium sulfate=75:25
   sodium alum:sodium silicate=100:0
   Amount of curing promoter to be added 3.5 parts by weight
COMPARISON 11
   Calcium chloride 2.0 parts by weight

Each sample from EXAMPLES 12 to 15 relating to the present invention has a remarkably higher primary curing strength and fairly higher final curing strength, and remarkably less spring back, in comparison with the traditional sample from COMPARISON 11, said traditional sample from COMPARISON 11, using calcium chloride as a curing promoter. Further, the sample from COMPARISON 10, in which sodium silicate is not added, has less primary and final curing strength and greater spring back than the samples from each EXAMPLE.

### INDUSTRIAL UTILITY

In the present invention, even if common portland cement and a wood reinforcement originating from a sort of wood containing a large amount of cement curing inhibitor are used, a wood cement board, having both a high primary curing strength, and a high final curing strength, can be provided.

TABLE 1

| | | EXAMPLE | EXAMPLE | EXAMPLE | EXAMPLE | EXAMPLE | EXAMPLE | EXAMPLE |
|---|---|---|---|---|---|---|---|---|
| | Composition | 1 | 2 | 3 | 4 | 5 | 6 | 7 |
| Surface and | Portland cement | 47.0 | → | → | → | → | → | → |
| back layers | Silica sand | 32.0 | → | → | → | → | → | → |
| | Wood flake | 15.0 | → | → | → | → | → | → |
| | Wood flour | 5.0 | → | → | → | → | → | → |
| | Crushed scrap of | 1.0 | → | → | → | → | → | → |
| | building board | | | | | | | |
| | Aluminium sulfate | 1.40 | 1.31 | 0.88 | 1.71 | 0.92 | 0.75 | 1.88 |
| | Sodium sulfate | 0.35 | 0.44 | 0.88 | 0.57 | 0.31 | 0.25 | 0.62 |
| | Sodium silicate | 1.75 | 1.75 | 1.74 | 1.22 | 2.27 | 1.00 | 2.50 |
| | Calcium chloride | | | | | | | |
| Core layer | Portland cement | 35.0 | → | → | → | → | → | → |
| | Fly ash | 22.0 | → | → | → | → | → | → |
| | Wood flake | 6.0 | → | → | → | → | → | → |
| | bundled wood | 10.0 | → | → | → | → | → | → |
| | Foamed | 1.0 | → | → | → | → | → | → |
| | polyetyrene | | | | | | | |
| | Crushed scrap of | 26.0 | → | → | → | → | → | → |
| | building board | | | | | | | |
| | Aluminium sulfate | 1.40 | 1.31 | 0.88 | 1.71 | 0.92 | 0.75 | 1.88 |
| | Sodium sulfate | 0.35 | 0.44 | 0.88 | 0.57 | 0.31 | 0.25 | 0.62 |
| | Sodium silicate | 1.75 | 1.75 | 1.74 | 1.22 | 2.27 | 1.00 | 2.50 |
| | Calcium chloride | | | | | | | |
| Mechanical | Bending strength | 4.0 | 4.5 | 4.0 | 4.0 | 3.8 | 3.4 | 4.4 |
| properties | after primary | | | | | | | |
| | curing (N/mm²) | | | | | | | |
| | Bending strength | 10.5 | 11.0 | 10.5 | 10.4 | 10.2 | 10.0 | 11.8 |
| | after secondary | | | | | | | |
| | curing (N/mm²) | | | | | | | |
| | Thickness | 0.2 | 0.2 | 0.2 | 0.3 | 0.3 | 0.4 | 0.2 |
| | swelling ratio (%) | | | | | | | |
| | specific gravity | 1.05 | 1.06 | 1.05 | 1.05 | 1.05 | 1.04 | 1.04 |

| | | COMPARISON | COMPARISON | COMPARISON | COMPARISON | COMPARISON |
|---|---|---|---|---|---|---|
| | Composition | 1 | 2 | 3 | 4 | 5 |
| Surface and | Portland cement | → | → | → | → | → |
| back layers | Silica sand | → | → | → | → | → |
| | Wood flake | → | → | → | → | → |
| | Wood flour | → | → | → | → | → |
| | Crushed scrap of | → | → | → | → | → |
| | building board | | | | | |
| | Aluminium sulfate | 1.58 | 0.26 | 2.36 | 0.38 | |
| | Sodium sulfate | 0.18 | 0.09 | 0.79 | 0.13 | |
| | Sodium silicate | 1.74 | 3.15 | 0.35 | 0.49 | |
| | Calcium chloride | | | | | 2.0 |
| Core layer | Portland cement | → | → | → | → | → |
| | Fly ash | → | → | → | → | → |
| | Wood flake | → | → | → | → | → |
| | bundled wood | → | → | → | → | → |
| | Foamed | → | → | → | → | → |
| | polyetyrene | | | | | |
| | Crushed scrap of | → | → | → | → | → |
| | building board | | | | | |
| | Aluminium sulfate | 1.58 | 0.26 | 2.36 | 0.38 | |
| | Sodium sulfate | 0.18 | 0.09 | 0.79 | 0.13 | |
| | Sodium silicate | 1.74 | 3.15 | 0.35 | 0.49 | |
| | Calcium chloride | | | | | 2.0 |
| Mechanical | Bending strength | 4.0 | 3.0 | 4.0 | 2.0 | 4.0 |
| properties | after primary | | | | | |
| | curing (N/mm²) | | | | | |
| | Bending strength | 9.8 | 9.5 | 9.0 | 7.5 | 10.5 |
| | after secondary | | | | | |
| | curing (N/mm²) | | | | | |
| | Thickness | 0.5 | 0.8 | 0.6 | 1.8 | 0.2 |
| | swelling ratio (%) | | | | | |
| | specific gravity | 1.03 | 1.00 | 1.00 | 0.95 | 1.05 |

Thickness swelling ratio was determined by measuring the thickness before and after the secondary curing.

TABLE 2

| | | EXAM- | EXAM- | EXAM- | EXAM- | COMPAR- | COMPAR- | COMPARI- | COMPARI- |
|---|---|---|---|---|---|---|---|---|---|
| | | PLE 8 | PLE 9 | PLE 10 | PLE 11 | ISON 6 | ISON 7 | SON 8 | SON 9 |
| Compositions | Portland cement | 75.0 | → | → | → | → | → | → | → |
| | Wood flake | 25.0 | → | → | → | → | → | → | → |
| | Aluminium sulfate | 1.40 | 0.88 | 0.75 | 1.88 | 1.58 | 0.26 | 0.38 | |
| | Sodium sulfate | 0.35 | 0.88 | 0.25 | 0.62 | 0.18 | 0.09 | 0.13 | |
| | Sodium silicate | 1.75 | 1.74 | 1.00 | 2.50 | 1.74 | 3.15 | 0.49 | |
| | Calcium chloride | | | | | | | | 2.0 |
| Mechanical | Bending strength | 6.0 | 6.0 | 5.0 | 6.2 | 5.5 | 5.0 | 4.2 | 5.5 |
| properties | after primary | | | | | | | | |
| | curing (N/mm²) | | | | | | | | |
| | Bending strength | 12.0 | 12.0 | 12.5 | 12.0 | 10.5 | 11.0 | 11.0 | 12.0 |
| | after secondary | | | | | | | | |
| | curing (N/mm²) | | | | | | | | |
| | Thickness | 0.1 | 0.2 | 0.2 | 0.1 | 0.2 | 0.4 | 0.8 | 0.1 |
| | swelling ratio (%) | | | | | | | | |
| | specific gravity | 1.10 | 1.08 | 1.09 | 1.12 | 1.09 | 1.07 | 1.11 | 1.11 |

Thickness swelling ratio was determined by measuring the thickness before and after the secondary curing.

TABLE 3

| | Compositions | EXAMPLE 12 | EXAMPLE 13 | EXAMPLE 14 | EXAMPLE 15 | COMPARISON 10 | COMPARISON 11 |
|---|---|---|---|---|---|---|---|
| Surface and | Portland cement | 47.0 | → | → | → | → | → |
| back layers | Silica sand | 32.0 | → | → | → | → | → |
| | Wood flake | 15.0 | → | → | → | → | → |
| | Wood flour | 5.0 | → | → | → | → | → |
| | Crushed scrap of | 1.0 | → | → | → | → | → |
| | building board | | | | | | |
| | Aluminium sulfate | 1.31 | 0.98 | 0.66 | 1.96 | 2.62 | |
| | Sodium sulfate | 0.44 | 0.33 | 0.22 | 0.66 | 0.83 | |
| | Sodium silicate | 1.75 | 2.19 | 2.62 | 0.88 | 0 | |
| | Calcium chloride | | | | | | 2.0 |
| Core layer | Portland cement | 35.0 | → | → | → | → | → |
| | Fly ash containing | 22.0 | → | → | → | → | → |
| | a large amount of | | | | | | |
| | curing inhibitor | | | | | | |
| | Wood flake | 6.0 | → | → | → | → | → |
| | Bundled wood | 10.0 | → | → | → | → | → |
| | fiber | | | | | | |
| | Foamed | 1.0 | → | → | → | → | → |
| | polyetyrene | | | | | | |
| | Crushed scrap of | 26.0 | → | → | → | → | → |
| | building board | | | | | | |
| | Aluminium sulfate | 1.31 | 0.98 | 0.66 | 1.96 | 2.62 | 0 |
| | Sodium sulfate | 0.44 | 0.33 | 0.22 | 0.66 | 0.88 | 0 |
| | Sodium silicate | 1.75 | 2.19 | 2.62 | 0.88 | 0 | 0 |
| | Calcium chloride | | | | | | 2.0 |
| Mechanical | Bending strength | 3.0 | 3.5 | 4.0 | 2.5 | 2.0 | 1.5 |
| properties | after primary | | | | | | |
| | curing (N/mm²) | | | | | | |
| | Bending strength | 10.0 | 10.5 | 11.0 | 10.0 | 9.3 | 8.0 |
| | after secondary | | | | | | |
| | curing (N/mm²) | | | | | | |
| | Thickness | 0.5 | 0.3 | 0.2 | 0.7 | 1.2 | 2.5 |
| | swelling ratio (%) | | | | | | |
| | specific gravity | 1.05 | 1.05 | 1.07 | 1.04 | 1.00 | 0.92 |

Thickness swelling ratio was determined by measuring the thickness before and after the secondary curing.

1. A method for manufacturing a wood cement board comprising; the scattering of an ingredient, wherein a sodium alum produced from aluminum sulfate and sodium sulfate, and sodium silicate are added to a mixture containing a cementitious inorganic powder and wood reinforcement on a base panel to form a mat having moist points, then effecting a primary curing of said mat by pressing and heating under its moist points, then curing said mat at room temperature or in an autoclave.

2. A method for the manufacturing of a wood cement board in accordance with claim 1, wherein the weight ratio of aluminum sulfate and sodium sulfate in said sodium alum is within the range of 80:20 to 50:50, and the weight ratio of said sodium alum and sodium silicate is within the range of 25:75 to 75:25, with 2.0 to 5.0 parts by weight of a curing accelerator mixture of said sodium alum and sodium silicate then being added to 100 parts by weight of a mixture of said cementitious inorganic powder and said wood reinforcement.

3. A method for the manufacturing of a wood cement board in accordance with claim 1, wherein said wood containing a large amount of cement inhibitor.

4. A method for manufacturing a wood cement board in accordance with claim 1, wherein said primary curing of said mat is carried out with said base panel, while said curing at room temperature or in said autoclave is carried out without said base panel.
